(19) United States
(12) Patent Application Publication
(10) Pub. No.: US 2005/0149435 A1
(43) Pub. Date: Jul. 7, 2005

(54) Method and system of securing a credit card payment

(76) Inventors: Stephane Petit, Saint Clair (FR); Francoise Vallee, Lantheuil (FR)

Correspondence Address: Blakely Sokoloff Taylor & Zafman, 12400 Wilshire Boulevard, 7th Floor, Los Angeles, CA, 90025, US

(21) Appl. No.: 10/509,296

(22) PCT Filed: Mar. 25, 2003
(86) PCT No.: PCT/FR03/00937

(30) Foreign Application Priority Data
Mar. 25, 2002 (FR) 02/03 678

(51) Int. Cl. G06F 17/60

(52) U.S. Cl. 705/39; 705/35

(57) ABSTRACT

The invention concerns a method of securing credit card transactions between a holder and a merchant, particularly via a telecommunication network, characterized in that it comprises the steps in which: the holder signifies to a third party his intention to enter into contact with the merchant; the holder enters into contact with the merchant through the third party; the third party establishes a link between itself and the holder, and between itself and the merchant; the third party manages the formation of temporary information, the entry of this information in the order form and the relational connection of the temporary information with the real bank information from the credit card of the holder to check the various authorizations with the banks for the acknowledgement of the order. The invention also relates to a system and a third party for implementing the method, and a computer program product included in the third party.

### FIELD OF THE INVENTION

The present invention relates to a technique for secure credit card transactions, particularly via a telecommunication network.

More precisely, it relates to making a credit card transaction between a holder and a merchant secure, this transaction being carried out over a telecommunication network or distance selling.

It applies in particular, but not in a limiting manner, to the field of payment using the Internet distance selling type of procedure.

In this application, a credit card is any type of card, a credit card in the true sense of the word, but also payment and debit cards, of the bank card type.

### STATE OF THE ART

It should be remembered that bank cards and/or credit cards comprise on the one hand a visual portion, and on the other hand a magnetic stripe, and a chip in some countries, these three portions containing information on the holder.

The information on the visual part is for example the name and forename of the holder and bank identification information of the card itself, particularly the number of the bank card and its expiry date. The visual portion of the card may include a manual signature of the holder.

The magnetic stripe, and the smart card where appropriate, contain the above information and additional information including the confidential code linked to the bank card (present in encrypted form). Financial transactions can be made with such credit cards.

Several financial transaction procedures are possible.

To make a bank or financial transaction, it is possible, according to a first possibility, to use only the information contained in the visual portion of the card. This procedure is called the distance selling procedure.

Only the information contained in the visual portion is required to validate the financial transaction.

This procedure is currently used over the telecommunication networks, for example the Internet, but also in the context of distance commerce, such as mail order for example, these sales capable of being made with the aid of telephones.

The second possibility uses the information contained on the magnetic stripe for making a financial transaction. In order to validate the financial transaction, a processing module situated at the merchant comprises means suitable for reading the information presented on the magnetic portion of the card. A manual signature of the holder in front of the merchant is used to identify the holder locally.

The latter procedure is currently used outside France.

However, the fact that only a manual signature is necessary to approve the transaction generates relatively high rates of fraud.

France has decided to use a more secure method for making transactions by credit card. In particular it uses a smart card.

The smart card has the capability, on the one hand, of authenticating on the occasion of each financial transaction by the credit card holder by presentation and local verification of the confidential code, and, on the other hand, of generating proofs on the purchase document with the aid of the personalized secrets that it contains.

Such transactions require the use of specific processing modules at the merchant. These processing modules contain in particular means suitable for reading the smart card.

To protect the financial transactions made during the commerce over a telecommunication network, it would be sufficient to use the same method. However, it is difficult to provide each user on the network with a processing module having the means of reading the smart card.

In addition, since France is one of the few countries currently using protection by smart card, such a provision of means would make it possible to carry out transactions only between French holders and French traders or merchants.

Consequently, financial transactions over telecommunication networks always use the methods using the visual portions of the credit card.

The ease with which the visual portions can be falsified (by computer generation of card numbers, or by theft) means that the rates of fraud on commerce via the telecommunication network are extremely high.

Several solutions aimed at protecting such transactions are already known.

They recommend that the card number of the holder should not circulate over the telecommunication network.

A first method consists in using electronic commerce platforms which suggest that the holder definitively registers his card number on his server and to use a pseudonym (such as a password, a login word, occasionally an additional questionnaire) in order to carry out the financial transactions.

The bank information of the holder no longer circulates on the network and the merchant must carry out a certain number of operations to obtain the information necessary to validate the transaction.

A second method substitutes a perfectly formed temporary number for the real bank card number of the holder. The holder collects from a specialized authorization center a series of temporary card numbers which will be used by the holder to buy products or services from the merchant during a transaction over the telecommunication network.

A center for authorizing the transaction then collects the financial transactions associated with a temporary number, replaces the temporary number with the real number of the bank card and returns the financial transaction to a real authorization center of the financial transactions of the bank of the holder.

These methods of securing commerce over the telecommunication network however have disadvantages.

The first method can be used to carry out financial operations only with a closed population of merchants. The second method requires the installation of specific means (such as for example a “wallet” or package of perfectly formed temporary card numbers) on the communication station of the holder. These means are connected to the station of the holder, and the latter will not be able to carry out secure commerce from another browser station on the network.

Finally, he has to carry out manipulations to complete the merchant order form with the aid of the temporary bank card numbers.

### SUMMARY OF THE INVENTION

The invention proposes to alleviate these disadvantages.

The main aim of the invention is to allow a user to carry out a secure bank card transaction over the communication network, this transaction being capable of being made from any communication terminal.

The communication terminal may for example be a browser station or for example a mobile telephone.

The invention consists in preventing bank information concerning the credit card of the holder from circulating over the network and to the merchant.

A further aim of the invention is to minimize as far as possible the involvement of the third party in the management of the transaction and particularly in the entry of the various temporary numbers of the credit card for example.

Accordingly, the invention proposes a method for secure credit card transactions between a holder and a merchant, particularly via a telecommunication network, by entering in the order form supplied by the merchant, during the payment phase of the transaction, temporary information consistent with the bank information from the card of the holder, this temporary information then being collected by an authorization center for the transaction in order to make a relational connection with the real bank information from the card of the holder for the acknowledgement of the order by the holder for the benefit of the merchant, characterized in that it comprises the steps in which:
the holder signifies to a third party his intention to enter into contact with the merchant before entering into contact with the merchant over the telecommunication network;
the holder enters into contact with the merchant through the third party;
the third party establishes a link between itself and the holder and between itself and the merchant;
the third party manages the formation of temporary information, the entry of this information in the order form and the relational connection of the temporary information with the real bank information from the credit card of the holder to check the various authorizations with the banks for the acknowledgement of the order.

Advantageously, the invention is supplemented by the following features, taken alone or in any one of their technically possible combinations:
the third party modifies the Internet addresses of the site of the merchant to constrain the browser of the holder to systematically transmit to it all the information from the holder to the merchant;
the third party modifies the Internet addresses of the site of the merchant to constrain the server of the merchant to systematically transmit to it all the information from the merchant to the holder;
if the holder has previously registered with the third party, he may choose not to indicate the bank information concerning him in the reserved domain of the order form of the transaction, and consequently not to complete said domain other than by an identifier with the third party, the portion requiring bank information being completed by the third party with temporary and coherent information, only this temporary information being sent to the merchant;
a procedure of verifying the intention of the holder to carry out the transaction is triggered; and
if the holder is not registered with the third party, he enters the bank information from his credit card in the order form supplied by the merchant via the third party, the third party then managing the completion of the order form which will be sent to the merchant with temporary information.

The invention also relates to a system and a third party used for implementing the method according to the invention. It also relates to a “computer program” product included in the third party.

Consequently, the invention does not require the installation of special hardware on the part of the holder.

Thus, the use of the method is not linked to the station or to the means linked to the holder.

The method increases the security of financial transactions over the telecommunication network, particularly the Internet, while ensuring that the merchant, or any other person present on the network, does not have access to the bank information on the card of the holder.

The method may be associated with the applications of the home bank.

Finally, the security method is compatible with all the merchant sites present on the telecommunication network.

The method may advantageously be supplemented by allowing the bank of the holder:
to offer online credit when the amount of the transaction is high,
to develop a true client relationship by instituting the passage via the home bank (providing information on the bank for example),
to handle other products relating to the payment for the client (deferred payment for example, opening of a specialist Internet account, etc).

### FIGURES

Other features, aims and advantages of the invention will emerge from the following description which is purely illustrative and nonlimiting and which must be read in relation to the appended drawings in which:

FIG. 1 represents, according to a block diagram presentation, the main steps of processing a financial transaction between a merchant and a holder;

FIG. 2 represents in block diagram form the various successive steps according to the first main step in FIG. 1;

FIG. 3 represents in block diagram form the various successive steps of the second main step in FIG. 1;

FIG. 4 represents the block diagram of the various successive steps of the third main step according to FIG. 1 of the financial transaction;

FIG. 5 represents in block diagram form the successive steps of the collection of the transactions, this collection being performed periodically;

FIG. 6 represents schematically the movements of the various steps between the holder, the third party and the merchant;

FIG. 7 represents schematically the system and the transactions used to apply the method according to FIG. 1;

FIG. 8 represents schematically the various bank transactions during a financial transaction, performed particularly with a method according to a variant of the invention.

### DETAILED DESCRIPTION OF THE INVENTION

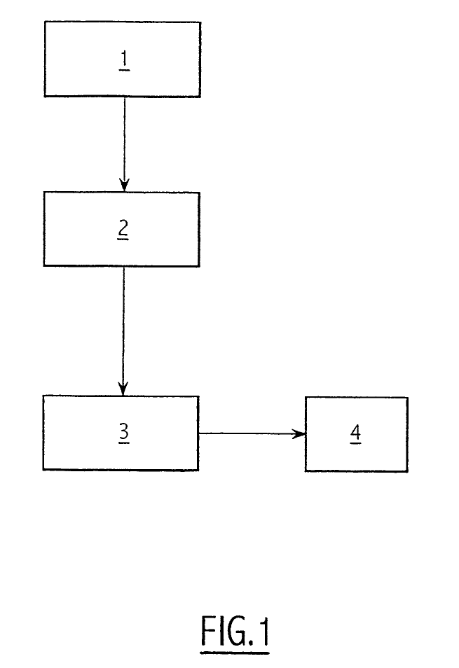

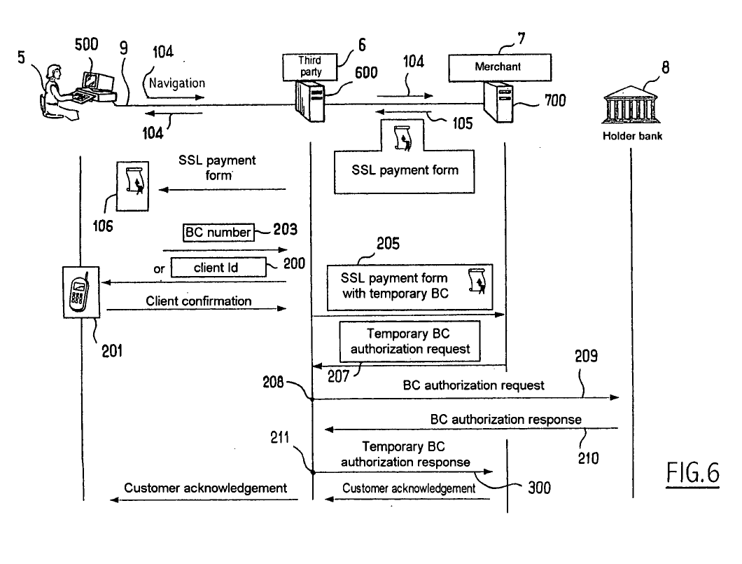

With reference to FIGS. 1 and 6, a holder 5 wishes to make a financial transaction with a merchant 7 over a telecommunication network 9.

FIG. 1 shows that this financial transaction comprises a first step 1 of ordering a product from the merchant 7, followed by a payment step 2. The payment is itself followed by a delivery step 3, followed, but not necessarily in correlated manner, by a step 4 of collecting all the financial transactions made by the merchant 7 with the various holders 5 over a telecommunication network 9.

The telecommunication network may be for example the Internet, but it may also be a mobile telephone network for example.

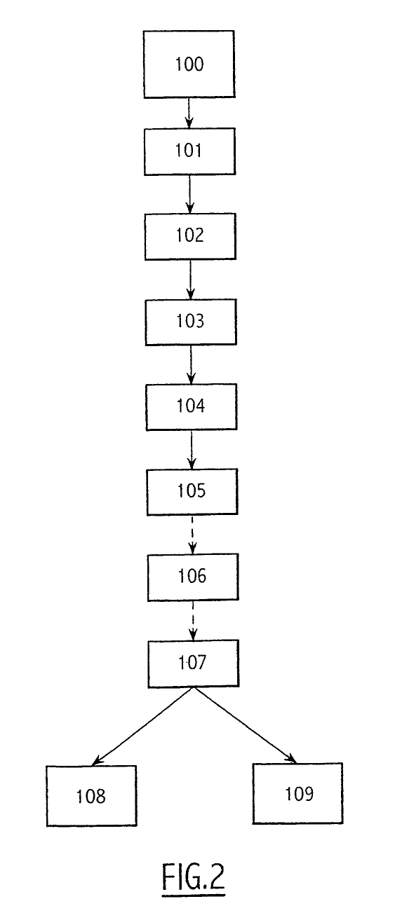

FIG. 2 breaks down the first phase of the financial transaction, that is the phase of ordering a product from a merchant 7, and shows the various successive steps in linear fashion.

According to a first step 100, the holder 5 indicates to a third party 6 his intention to carry out a financial transaction and place an order for a product with a merchant 7. This financial transaction is carried out over a telecommunication network 9.

The third party 6 is present in a space of the Secure Commerce Space type.

The third party 6 may be a “Web” server or intermediate Internet or any network equipment.

Step 100 therefore consists for the holder 5 in logging onto the site of the third party over the telecommunication network 9.

Accordingly, the holder 5 has means 500—shown in FIG. 6—for navigating and logging onto the telecommunication network 9, for example of the Internet type. The means 500 may therefore for this purpose comprise a telecommunication terminal of the microcomputer type, or a mobile telephone allowing browsing over a telecommunication network.

Step 101, subsequent to step 100, sees the third party 6 establish, thanks to the means 600, a link with the holder 5. The type of link depends on the terminal from which the financial transaction is carried out.

In the case of a terminal of the microcomputer type allowing an Internet link, the link may advantageously be a link of the Secure Socket Layer type (or SSL as indicated in FIG. 6).

Thanks to this link, a diversion made by the third party 6 is possible and is used to intercept and control all the information from the means 500 of the holder to the telecommunication network 9.

In the case of a telecommunication terminal comprising a mobile telephone, the link is not a link secured by an SSL means.

In step 102, the holder 5 indicates with which merchant 7 he wishes to place an order and consequently where necessary set up a bank transaction. This indication is made by entering on these means 500 the address of the merchant 7 on the site of the third party 6 on the network.

In the case of the Internet, it is the Internet address or “Uniform Resource Locator” (URL) of the merchant.

Based on this entry and the validation of this entry, step 103 consists for the third party 6 in electronically decapsulating, using the means 600, the page or the site of the merchant 7 over the telecommunication network 9, in order to set up a link, possibly also secure, between the third party 6 and the merchant 7. This secure link is also advantageously of the Secure Socket Layer (SSL) type in the case of commerce over the Internet. The decision to secure the interchanges by an SSL link lies with the merchant 7.

To set up a secure link, the third party 6 modifies the relative or absolute Uniform Resource Locator (URL) addresses of the site of the merchant 7 over the telecommunication network, to constrain the browser of the holder 5 (included in the means 500) to systematically transmit to said third party 6 all information from the merchant to the holder 5 and from the holder 5 to the merchant 7.

At the end of step 103, all the transactions between the holder 5 and the merchant 7 are therefore controlled by the third party 6.

However, this omnipresence of the third party 6 during the transfer of the information between the holder 5 and the merchant 7 is totally transparent for the holder 5 and for the merchant 7.

The holder 5 browses over the telecommunication network 9 and on the page of the merchant 7 in the same manner as if the third party 6 did not have total control of the transfer of information between the two parties 5 and 7.

Step 104 therefore consists for the holder 5 in browsing on the site of the merchant 7 and choosing a product that he wants to buy.

Step 105 corresponds to the end of the choice of the holder 5 of a product which he wants to buy and to the transmission by the merchant of an order form or payment form to be completed by the holder 5.

The order form is transmitted to the holder 5 in step 106.

The transmission is made via the third party 6, as indicated by the dashed lines in FIG. 2 between steps 105 and 106.

Step 106 therefore consists for the holder 5 in completing the order form. This order form requires the completion of several fields, particularly of information on the physical location of the holder 5 for purposes of delivering the product, and the fields concerning the bank information from the credit card of the holder 5.

In this step 106, the holder must complete at least the information concerning his physical location (home address, delivery address).

Step 107, preceded by dashed lines to represent the intervention of the third party 6, shows that there is an option at this point. The option is to know whether the holder 5 has previously registered with a register included in the means 600 of the third party 6, or whether he has not previously registered with or declared himself to said third party 6.

This registration with the third party consists particularly in the transmission of bank information concerning the credit card of the holder 5.

This bank information is particularly the bank card number and the expiry date of the credit card of the holder 5.

Step 108 shows the case where the holder 5 has indeed previously declared himself to the third party 6.

Step 109 shows the case where the holder 5 has not previously declared himself to the third party 6.

It should be noted that steps 100 to 109 are the successive steps of the first main step 1 in FIG. 1, that is the ordering of the product.

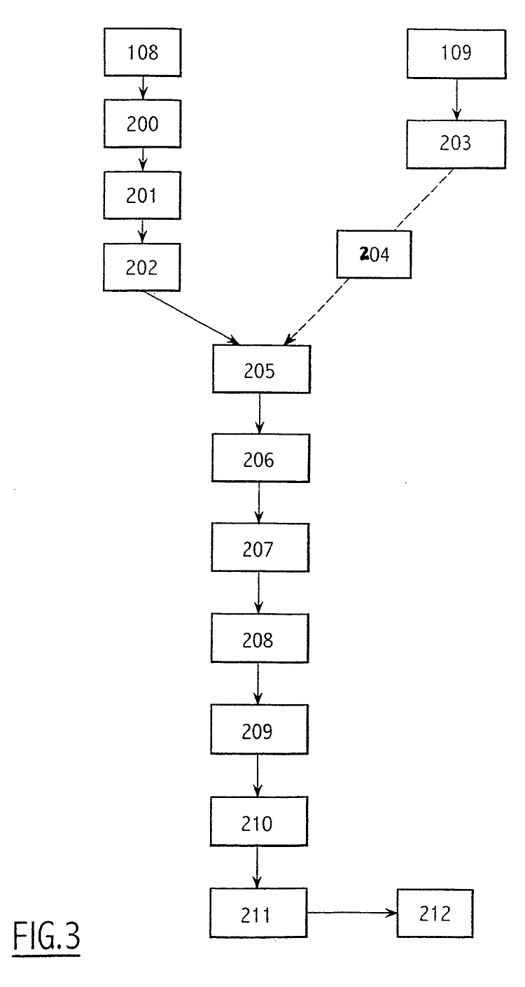

FIG. 3 begins with steps 108 and 109 and details the various successive steps of the second main step of the financial transaction represented in FIG. 1, that is the payment for the order.

A first portion of FIG. 3 shows that, from step 108, that is to say the case where the holder 5 has previously declared himself to the third party 6, a step 200 is then carried out in which the holder 5 completes only briefly the fields concerning the bank information from the credit card.

He may then for example complete the field concerning his credit card number or the expiry date of said credit card merely with an identifier with the third party 6. This identifier may be a password, an encrypted code, or the telephone coordinates at which the holder 5 can be contacted (mobile telephone coordinates for example).

Step 201 consists in checking the intention of the holder 5 to carry out the financial transaction with the merchant 7.

Several methods of verifying the intention of the holder 5 are possible.

A first possibility is to call back the holder 5 on his mobile telephone, the holder 5 then indicating to the third party 6 his agreement to carry out the bank transaction by entering a password on his mobile telephone keypad, this entry being sent directly to the means 600 of the holder 6 or via a short message by mobile telephony, short message service (SMS).

The return message from the mobile telephone may also comprise an electronic signature.

A second possibility for verifying the intention of the holder 5 may also be to force the holder 5 to enter a specific password in a secure window appearing on his means 500.

A third possibility is to send an email to the means 500 of the holder 5, the holder 5 then having to return the email with an identifier to confirm the transaction.

Finally, it is possible to verify the electronic signature of means possessed by the holder 5, for example a smart card, this smart card being inserted into the specific reading means connected to the telecommunication network 9.

When the intention of the holder 5 is verified, step 202 consists in the third party 6 completing the order form with the aid of numbers and temporary and coherent bank information so that the merchant 7 believes that this bank information is the real bank information of the holder 5.

The analysis now resumes from step 109, that is when the holder 5 has not declared himself to the third party 6.

In step 203, the holder 5 is obliged to complete the order form supplied by the site of the merchant 7 with the aid of the bank information from his credit card.

Step 204 then consists in the third party 6 completing the fields concerning the bank information of the holder 5 with temporary and coherent bank information.

At the end of steps 202 and 204, the order form supplied by the merchant 7 is then completed with temporary bank information.

This temporary information is therefore completely different from that on the credit card of the holder, but appears coherent to the eyes of a banking organization.

Step 205, common with the two procedures from steps 108 and 109, consists in sending the modified order form to the site of the merchant 7.

In step 206, the merchant may, if he wishes, send this temporary information to an authorization center attached to his bank. In any case, step 207 is reached.

Step 207 and the bank circuit shown in FIG. 8 then show that the bank authorization request returns to the authorization center of the third party 6. This authorization center 602 is connected to the means 600 of the third party 6 by processing means 601.

During step 208, the third party 6 converts the temporary numbers into the real numbers or bank information of the holder 5.

Step 209 consists in sending a request for authorization of the financial transaction to the authorization center of the bank 8 of the holder 5.

When this authorization has been obtained, during step 210, the bank of the holder 8 returns the authorization to the third party 6 which, in step 211, converts the real bank information into the temporary information of the holder 5.

These various conversions are carried out by the means 601 of the third party 6.

Step 212 consists in sending the authorization to the authorization center of the bank of the merchant, this step being included only if step 206 is also.

At the end of step 212, the authorization center of the merchant has obtained authorization of the bank transaction.

Step 300 consists in sending this transaction authorization to the site of the merchant 7.

Then begins the first step of the third main step 3 of the financial transaction shown in FIG. 1, that is the finalization of the order and the information concerning delivery.

In step 301, the site of the merchant 7 generates a delivery note and sends it to the holder 5. This delivery note then confirms that the transaction has indeed been carried out, the various transaction authorizations having been obtained.

The dashed lines between step 301 and 302 show that the third party 6 again controls this information.

Step 303 shows the end of the financial transaction.

The various steps are repeated schematically in FIG. 6. This contains the various movements between the holder 5, the third party 6, the merchant 7 and the bank of the holder 8.

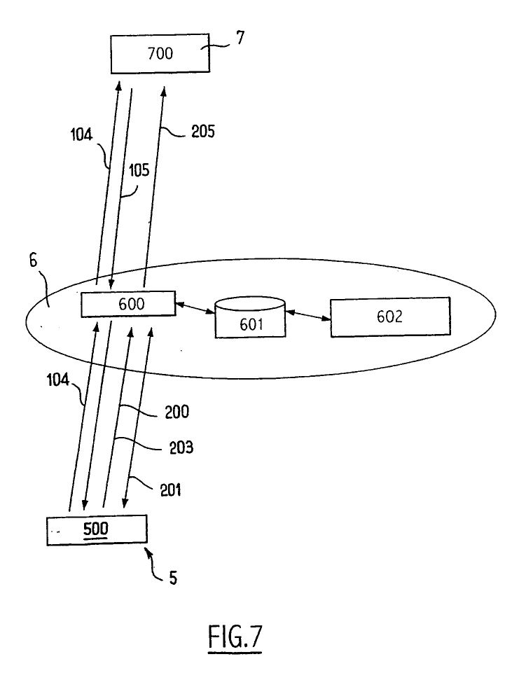

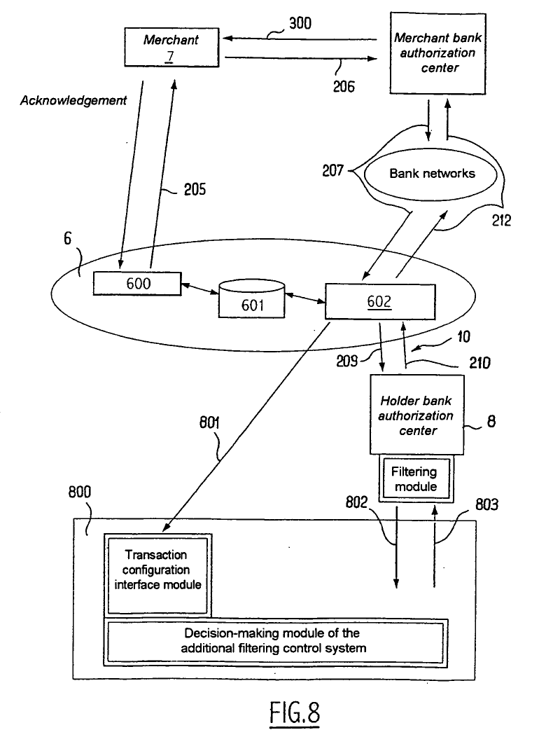

FIG. 7 repeats in schematic form some steps shown in FIG. 6.

It shows in particular the means 700 of the merchant 7, the means 600, 601 and 602 of the third party 6.

The means 601 are in particular used to convert and reconvert the bank information numbers into temporary information.

The means 602 comprise the authorization center connected to the third party 6.

The browsing means 500 of the holder 5 are also shown in this figure.

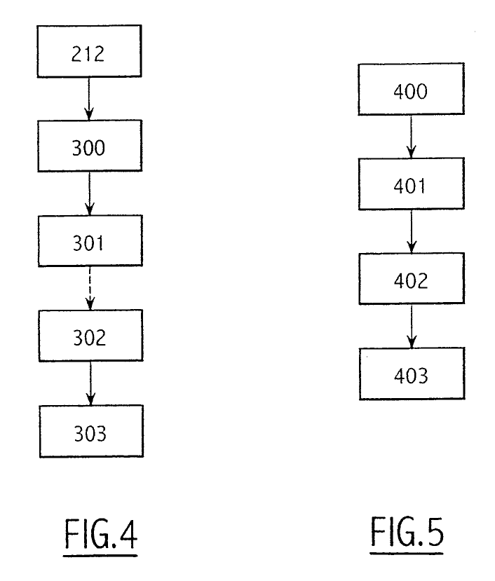

FIG. 8 is a schematic view representing certain steps in FIGS. 2 to 4 and in particular the bank circuit in its entirety. The authorization center of the bank of the merchant 7 is also shown, which is reflected in the block diagrams in FIG. 3 by the presence of steps 206 and 212.

FIG. 8 represents in particular a variant of the invention; this variant will be described in greater detail in the rest of the present description.

FIG. 5 represents a series of steps that are carried out after the conclusion of the financial transaction, and where necessary in decorrelated manner.

During a first step 400, the merchant 7 collects via his remote collection center all the transactions that have been carried out over the telecommunication network during a given period with holders 5.

The collection is made as a function of the various third parties 6, that is that the collection center of the merchant 7 carries out a group collection for each given third party.

Step 401 consists in the third party 6 receiving all the transactions made during the given period with the various holders 5.

Step 402 consists in the third party converting all the temporary information—temporary information which is the only information to which the merchant has always had access—into the real bank information of the various holders.

Step 403 consists in sending the various numbers and bank information to the banking establishments of the various holders 5, in order that the merchant 7 is effectively paid.

FIG. 8 describes more precisely a variant according to the invention.

According to this variant, the third party 6 (comprising the means 600 to 602) is supplemented by a Bank Client Profile (PCB) module 800 which is included in the authorization center of the holder.

A secure link 10 is set up between the authorization center of the holder 8 and the authorization center 602 connected to the third party.

The Bank Client Profile module 800 receives via this secure link 10 the bank authorization requests originating from the authorization center 602.

An interdiction of the acknowledgement of a transaction made by the holder over the telecommunication network is entered by default in the authorization center 8 of the holder.

The authorization center 602 connected to the third party configures, during step 801, the PCB module so that it gives the authorization center 8 of the holder 5 information for the release, transaction by transaction, of this interdiction according to questioning steps, step 802, on the authorization of a financial transaction.

Questioning step 802 follows an authorization request in step 209. Step 209 is carried out when the PCB module has been configured in step 801.

The transactions via the telecommunication network are therefore unlocked one after the other individually.

Then, the questioning steps 802 of the PCB module is followed by a release authorization 803 to the authorization center 8 of the holder 5.

The normal course of steps then resumes as shown 1 to 7.

The addition of this PCB module 800 in association with the authorization center 602 connected to the third party greatly increases the security of the transactions.

When the authorization center of the bank of the holder calls the PCB (Bank Client Profile), the latter makes a certain number of additional checks relating to the pre-authorization details. After these checks the PCB may or may not authorize the financial transaction.

For example, when the financial transaction is made with the aid of the chip on the smart card or originates from a processing of the bank card by an automated teller machine, the authorization center of the bank of the holder continues its usual processes without calling the PCB.

On the other hand, when the financial transaction is not made with the aid of the chip on the card or does not originate from a processing of the bank card in an automated teller machine, the authorization center of the bank of the holder calls the PCB.

This method of using the PCB module is for example described in patent application No. 01 01453.

It should be noted that the method according to the invention may advantageously be supplemented by allowing the bank of the holder:
to offer online credit when the transaction amount is large,
to develop a true client relationship by instituting the passage via the home bank (providing information on the bank for example),
to handle other products relating to the payment for the client (deferred payment for example, opening of a specialist Internet account, etc).

It should also be noted that the preceding description has preferentially described a secure link of the SSL type between the holder and the third party, and between the merchant and the third party, but a secure link of another type or a nonsecure link may be envisaged between the holder and the third party and/or between the third party and the merchant, particularly when the terminal of the holder is a mobile telephone.

1. A method for secure credit card transactions between a holder and a merchant, particularly via a telecommunication network, by entering in an order form supplied by the merchant, during the payment phase of the transaction, temporary information consistent with the bank information from the card of the holder, this temporary information then being collected by an authorization center for the transaction in order to make a relational connection with the real bank information from the card of the holder for the acknowledgement of the order by the holder for the benefit of the merchant, characterized in that it comprises the steps in which:
the holder signifies to a third party his intention to enter into contact with the merchant before entering into contact with the merchant over the telecommunication network;
the holder enters into contact with the merchant through the third party;
the third party establishes a link between itself and the holder and between itself and the merchant;
the third party manages the formation of temporary information, the entry of this information in the order form and the relational connection of the temporary information with the real bank information from the credit card of the holder to check the various authorizations with the banks for the acknowledgement of the order.

2. The method as claimed in claim 1, characterized in that the third party modifies the Internet addresses of the site of the merchant to constrain the browser of the holder to systematically transmit to it all the information from the holder to the merchant.

3. The method as claimed in claim 1, characterized in that the third party modifies the Internet addresses of the site of the merchant to constrain the server of the merchant to systematically transmit to it all the information from the merchant to the holder.

4. The method as claimed in claim 1, characterized in that, if the holder has previously registered with the third party, he may choose not to indicate the bank information concerning him in the reserved domain of the order form of the transaction, and consequently not to complete said domain other than by an identifier with the third party, the portion requiring bank information being completed by the third party with temporary and coherent information, only this temporary information being sent to the merchant.

5. The method as claimed in claim 1, characterized in that a procedure of verifying the intention of the holder to carry out the transaction is triggered.

6. The method as claimed in claim 1, characterized in that, if the holder has not registered with the third party, he enters the bank information from his credit card in the order form supplied by the merchant via the third party, the third party then managing the completion of the order form which will be sent to the merchant with temporary information.

7. A system for secure credit card transactions between a holder and a merchant, particularly via a telecommunication network, comprising means forming a third party connected via the network between the holder and the merchant, the third party comprising means for simultaneously establishing a link between itself and the holder, and between itself and the merchant, the third party also comprising means for forming temporary information consistent with the bank information from the card of the holder, the system comprising means forming a center for authorizing the transaction and suitable for collecting this temporary information in order to place it in a relational connection with the real bank information from the card of the holder for the acknowledgement of the order by the holder to the benefit of the merchant, characterized in that it comprises means suitable for allowing the holder to signify to the third party his intention to enter into contact with the merchant before entering into contact with the merchant over the telecommunication network, the third party comprising means suitable for entering in the order form the temporary information consistent with the bank information from the card of the holder.

8. The system as claimed in claim 7, characterized in that it also comprises means for intercepting and controlling all the information transmitted by the holder to the merchant.

9. The system as claimed in claim 7, characterized in that the third party comprises means suitable for modifying the Internet addresses of the site of the merchant and suitable for constraining the browser of the holder to systematically transmit to it all the information from the holder to the merchant.

10. The system as claimed in claim 7, characterized in that the third party comprises means suitable for modifying the Internet addresses of the site of the merchant and suitable for constraining the server of the merchant to systematically transmit to it all the information from the merchant to the holder.

11. The system as claimed in claim 7, characterized in that it comprises:
means forming a bank authorization center connected to the third party and collecting the bank authorization request that comes from the merchant or from his bank and that contains the temporary information;
means suitable for carrying out a conversion making a relational connection of the temporary information with the real bank information;
means suitable for sending the real bank information of the holder to the bank authorization center of the holder;
means suitable for retrieving the response from the bank authorization center of the holder containing the real bank information;
means suitable for carrying out a conversion in order to remake a relational connection of the real bank information with the temporary information;
means suitable for returning to the merchant or to the authorization center of his bank the response from the bank authorization center of the holder containing the temporary information.

12. The system as claimed in claim 11, characterized in that the means forming the authorization center of the holder also comprise a Bank Client Profile module suitable for receiving, via a secure link, the bank authorization requests originating from the authorization center connected to the third party, this module being suitable for being configured by the authorization request center connected to the third party so that it gives to the authorization center of the holder information for the release, transaction by transaction, of an interdiction to acknowledge the transactions made by the holder via the telecommunication network.

13. The system as claimed in claim 7, characterized in that it comprises a center for collecting the transactions of the merchant, said collection center comprising means suitable for periodically sending all the transactions made between said merchant and holders via the third party to a collection center linked to the third party, the means of the third party being suitable for again converting the temporary information into the real bank information of the various holders, the collection center linked to the third party comprising means suitable for redistributing the transactions to the various collection centers of the banks of the holders.

14. A third party for securing credit card transactions between a holder and a merchant, particularly via a telecommunication network, suitable for being connected via the network between the holder and the merchant, the third party comprising means for simultaneously establishing a link between itself and the holder, and between itself and the merchant, the third party also comprising means for forming temporary information consistent with the bank information from the card of the holder, characterized in that it comprises means suitable for receiving an information item from the holder to signify to the third party his intention to enter into contact with the merchant, before entering into contact with the merchant over the telecommunication network, the third party also comprising means suitable for entering in the order form the temporary information consistent with the bank information from the card of the holder.

15. A “computer program” product recorded on a medium that can be used in a computer of a third party for securing credit card transactions between a holder and a merchant, particularly via a telecommunication network, the third party being capable of being connected via the network between the holder and the merchant, the product comprising programming means that can be read by the third party to simultaneously establish a link between the third party and the holder, and between the third party and the merchant, the product also comprising programming means that can be read by the third party to form temporary information consistent with the bank information from the card of the holder, characterized in that it comprises programming means that can be read by the third party for receiving an item of information from the holder to signify to the third party his intention to enter into contact with the merchant, before entering into contact with the merchant over the telecommunication network, the medium also comprising programming means that can be read by the third party for entering in the order form the temporary information consistent with the bank information from the card of the holder.
